(19) United States
(12) Patent Application Publication
(10) Pub. No.: US 2013/0186342 A1
(43) Pub. Date: Jul. 25, 2013

(54) corn bank double gate internal feeder attachment

(71) Applicants: Kenneth Salinas, Laredo, TX (US); Cordelia Salinas, Laredo, TX (US)

(72) Inventors: Kenneth Salinas, Laredo, TX (US); Cordelia Salinas, Laredo, TX (US)

(21) Appl. No.: 13/796,739

(22) Filed: Mar. 12, 2013

Related U.S. Application Data
(63) Continuation-in-part of application No. 12/898,838, filed on Oct. 6, 2010.

(51) Int. Cl. A01K 5/02; F16K 31/04

(52) U.S. Cl. CPC A01K 5/0291; A01K 5/02; F16K 31/04
USPC 119/51.11; 119/57.92; 251/129.15

(57) ABSTRACT

A gate valve unit that can be used with existing wild animal feeders that have a spinning feed dispensing member. The invention typically includes two flat plate sliding gates that are solenoid actuated and are pulled closed by return springs. The spinning member and the sliding gates can be actuated together by either a timer or by a wireless command from a remote location. The unit can be equipped with a rechargeable battery optionally charged from a solar panel.

This is a continuation-in-part of application Ser. No. 12/898,838 filed Oct. 6, 2010. application Ser. No. 12/898,838 is hereby incorporated by reference in its entirety.

### BACKGROUND

1. Field of the Invention

The present invention relates generally to animal-feeding devices used outdoors to feed livestock automatically or supplying food to game animals and more particularly to an animal feeder system with remote communication.

2. Description of the Prior Art

U.S. Pat. No. 3,195,508 is a game and stock feeder that is automatically operable to spread a desired amount of feed at a predetermined time and for a pre-selected period. It uses a timing mechanism and does not require the presence of an operator.

U.S. Pat. No. 6,779,487 is an automated livestock feeder for storing and dispensing food such as hay or granular feed in a feed container to an animal at predetermined intervals. It utilizes a tray control flange which releases a feed tray. At a predetermined feeding time, a motor rotates the flanged latch thereby releasing the tray to rotate from a storage position to a dispense position. The activation mechanism includes an electrical power source, a timer relay/mechanical switch, and an electrical motor.

U.S. Pat. No. 4,722,300 is a programmable, automatic feeder for pets and other animals that dispenses a measured amount of food at a predetermined time. A digital clock control mechanism, including an adjustable portion control knob, controls a battery-operated motor. The motor drives an eccentric weight to vibrate a vibrating conveyor pan attached to the motor.

U.S. Pat. No. 4,491,086 is an automatic animal feeder comprising a housing defining a feeding reservoir therein. An inlet opening is provided for receiving feed in the reservoir. An outlet is associated with a motor-driven discharge device for conveying feed to a remote discharge outlet. An automatic timer controls a drive for operating the discharge device at predetermined time intervals and for predetermined time periods to thereby control the quantity of feed discharged at the remote discharge outlet during each of the time intervals.

U.S. Pat. No. 4,235,200 is an automatic animal feeder comprising a housing with a hopper for storing large amounts of dry food, and a food-delivery chamber positioned below for holding a fixed portion of dry feed received from the hopper. The food delivery chamber pivots at regular intervals from a loading position to a delivery position whereby the fixed portion of dry feed is discharged into an area accessible to an animal.

U.S. Patent Application #20080029034 is a method and apparatus for automatic feeding of animals with a food hopper connected to a feeding trough. Bulk animal food loaded into the hopper transfers into the feeding trough. A lid covers the feeding trough, preventing access to the animal food. An automated drive mechanism having a timer opens the lid, thereby allowing access to the animal food in the feeding trough, at pre-set intervals. The automatic animal feeder can be used to train wild game to feed during certain desired periods, such as daylight hours.

None of the prior art offers the combination of animal-feeder with the capacity to communicate the device's feed levels, feeder jams, and battery-life status to a remote location.

### SUMMARY OF THE INVENTION

The present invention relates to a game or livestock feeding unit with remote communications. It is an object of this invention to provide a game-animal feeding unit in combination with electronic sensors that monitor the status of the feeding unit. Among its features is a volume sensor that monitors the quantity of feed in its unit and transmits that information to a distant location. Another object of this invention is to dispense feed at programmed intervals, and to communicate feeder jams and battery-life status. In addition, the unit prevents unwanted animals from accessing the feed inside the feeding unit. An optional GPS can be provided that can be interrogated or can report location.

Other objects of the present invention, as well as particular features, elements, and advantages thereof, will be shown in the following description and accompanying figures.

### DESCRIPTION OF THE FIGURES Attention is now directed to several illustrations to better understand features of the present invention.

FIG. 1 an isometric view of the embodiment.

FIG. 2 is a detailed view showing the embodiment engaged with a feed container.

FIG. 3 is a perspective view of the primary components of the embodiment.

FIG. 4 is a detailed view of the communication ports.

FIG. 5 is a section view of the mechanical and electrical parts of the embodiment.

FIG. 6A shows a cut-open view of an embodiment of the present invention.

FIG. 6B shows a sectional view.

FIGS. 7A-7F show of a sliding gate embodiment.

FIGS. 8A-8D show details of the embodiment of FIGS. 7A-7F.

Several drawings have been presented to aid in understanding the invention. The scope of the present invention is not limited to what is shown in the figures.

### DESCRIPTION OF THE INVENTION

The present invention relates to an animal feeder with remote communications that can report quantity of feed remaining, battery status and can dispense on a predetermined schedule.

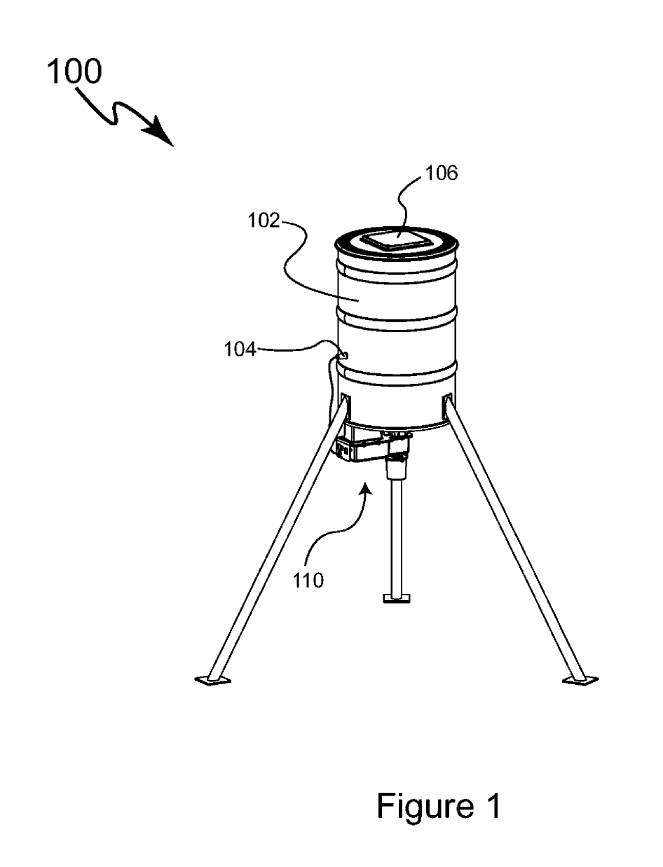

Referring to FIG. 1, the present invention is a game-animal feeder 100 that can include a feed drum 102, that holds feed, and a volume sensor 104 and solar panel 106 on the feed drum. A feed-dispersion mechanism in combination with a data acquisition unit and remote communication module 110 are generally attached to the underside of the feed drum 102.

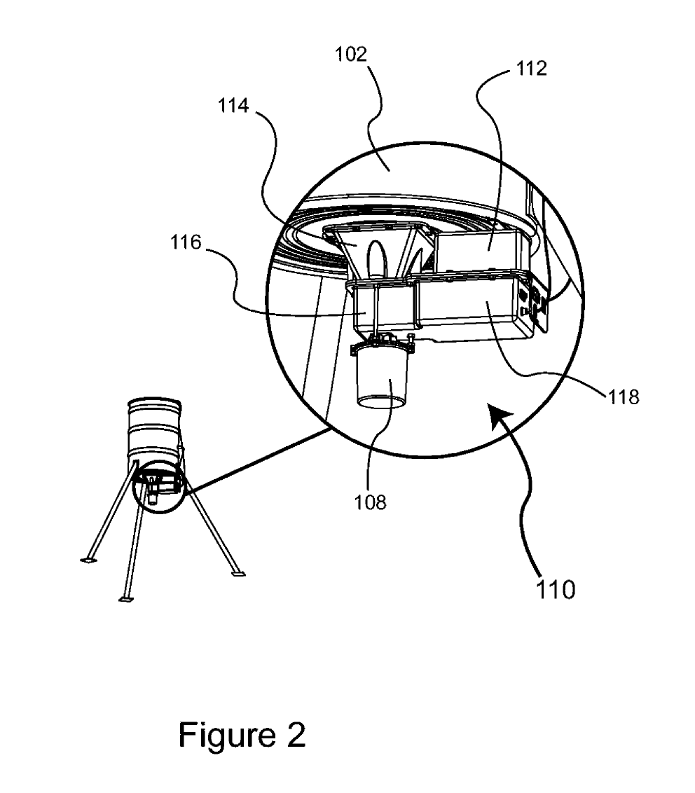

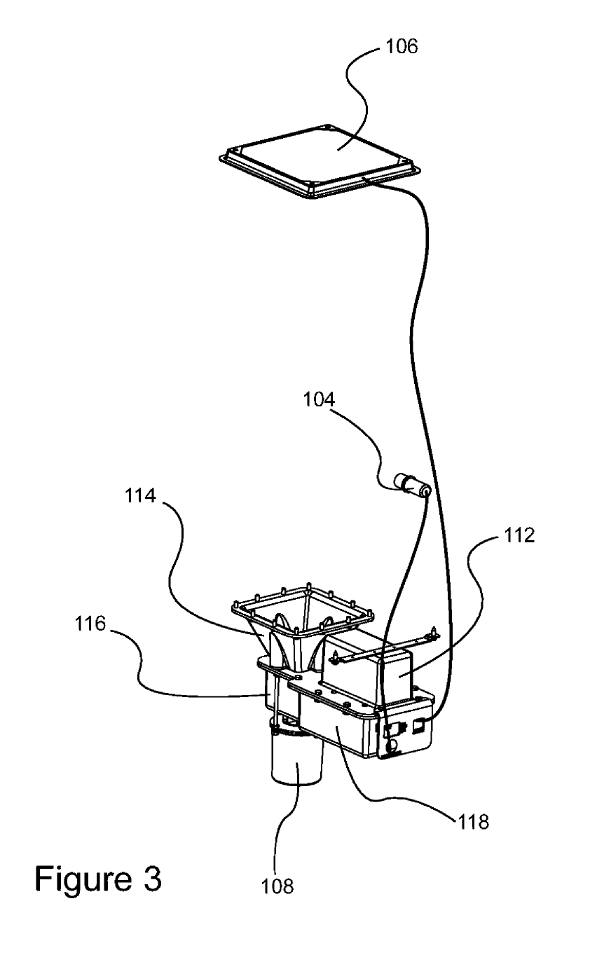

Referring to FIGS. 2 and 3, an embodiment of the system is shown without the feed drum. The feed-dispersion mechanism, in combination 110 with a data acquisition unit and remote communication module includes a battery 112 and communication housing attached to a drive-unit housing 118 that is connected to a feed spreader 116. The feed spreader 116 couples to a motor 108 and a funnel 114. The feed-funnel 114 is shown connected to the underside of the feed drum. The combination 110 is generally attached to the bottom portion of a feed drum 102 (FIG. 2); however, any other location is within the scope of the present invention. A solar panel 106 (FIG. 3) provides power to the unit and is connected with the unit via a power transmission line. A volume sensor 104 is normally attached to the unit.

Referring to FIG. 4, a detailed view of the embodiment illustrates various electronic and communication ports engaged with the housing 118 including an information port 122, a power input 124 and a feed-level-sensor input 120. A wireless interface 113 can also be seen.

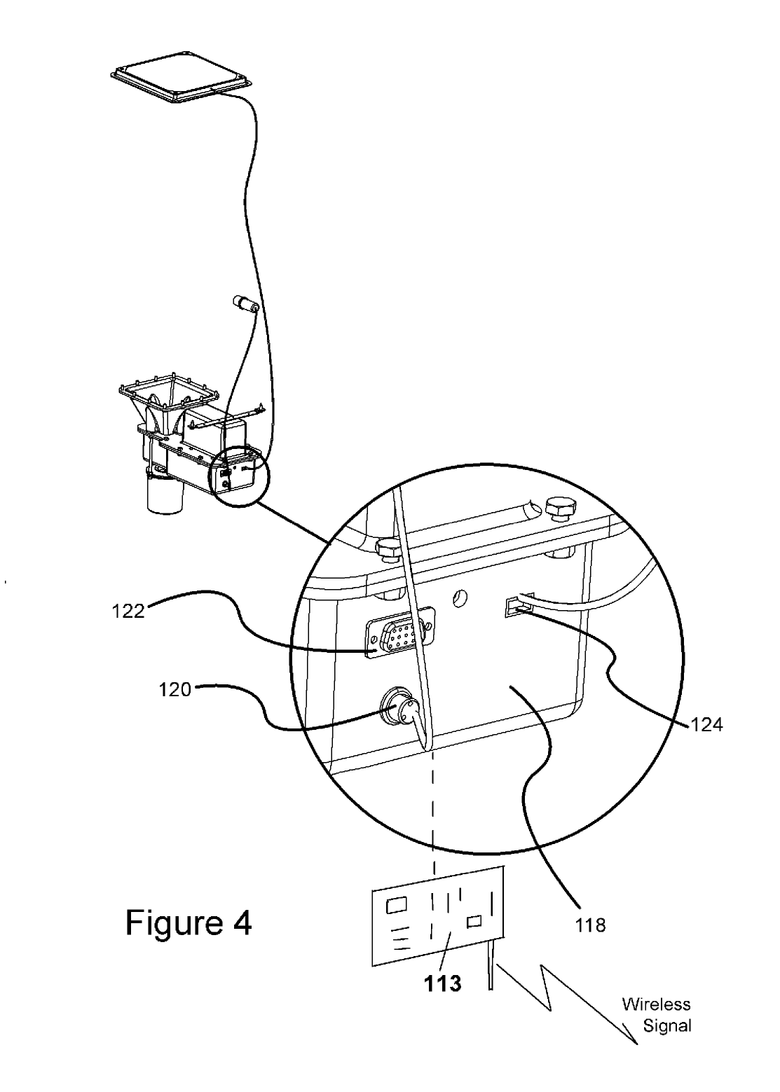

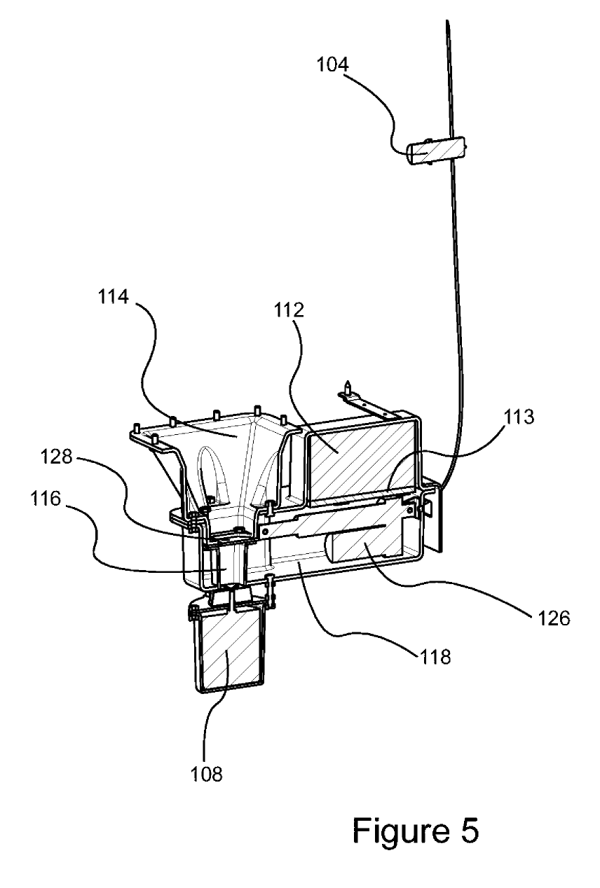

FIG. 5 is a cut-away view of the combination 110. The motor 108 is rotationally engaged with the feed-dispersion device 116 that is attached to the funnel 114. The path from the funnel to the feed-dispersion device 116 is opened or closed by a slide gate 128. The slide gate is controlled by a linear actuator 126 such that when power is supplied to it, the slide gate 128 can be either opened or closed. When the slide gate is in the open position, the feed dispersion device 116 can be rotated to disperse feed to the funnel. When there is no power, for whatever reason, the slide gate 128 is normally closed.

A circuit board 113 is equipped with the power and communication ports shown in FIG. 4. Communication and computing technology including a processor or central processing unit (CPU), a programmable logic controller (PLC) or the like are typically employed and not shown in detail, but are represented by circuit board 113. Any processor, microprocessor, controller, microcontroller, PLC or other computing device is within the scope of the present invention. A timer in the processor or on the circuit board 113 initiates the feed-dispersion process by sending power from the battery 112, to the linear actuator 126, thus opening the slide gate 128 and then supplying power to the motor 108 to rotate the feed dispersion device 116 that disperses feed from the funnel 114.

Feed quantity information from the volume sensor 104 is supplied to the processor as often as necessary. A low-volume signal from the volume sensor 104 can shut down the feed-dispersion process and send a signal to a remote location via wireless communication technology. Alternatively, the feed quantity, battery charge and/or other parameters can be transmitted on a schedule or can be interrogated from a remote station.

The combination 110 also includes a wireless communication module on the circuit board 113 or elsewhere. The wireless communications module can communicate with a remote location via cellular telephone, WiFi, satellite telephone or other satellite communications, or by any other wireless technique. The preferred communications technique is either cellular telephone or satellite telephone. The communications can be one direction from the feeder to the remote location to report acquired data, or it can optionally be bi-directional. Data can be optionally acquired regarding feed level, battery status, feed jams or any other acquired data parameter.

The combination 110 can optionally contain a GPS receiver on the circuit card 113 or elsewhere that can be aware of the feeder's location. Bi-directional wireless communication can optionally interrogate the GPS as to location. This can be useful to determine if a remote feeder has been moved, etc. The system could report location periodically or upon interrogation.

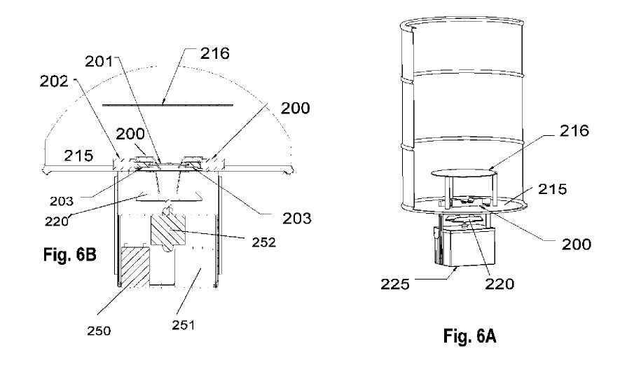

Turning to FIGS. 6A-6B, an alternative embodiment of the present invention can be seen. This embodiment is a sliding gate valve attachment that can go inside an existing feeder to control the distribution of feed (typically corn) and keep critters from getting at the feed. This embodiment can also be used with the embodiments herein described. When used with existing feeders, the gate valve of the present invention can be held in place with magnets, or can be bolted in place.

Feeders of this type typically include a feed can 215 that holds feed with a lower port that allows feed to drop onto a spin cast 220 that spins and spreads the feed in the vicinity of the feeder. This embodiment of the invention includes a gate valve 200 that can be placed or attached over the feed exit port inside the feed container 215. A battery box 225 is typically mounted below the feed container with a motor that drives the spin cast 220. A baffle plate 216 can be optionally mounted above the gate valve 200 to take some of the weight of the feed off of the gate. The gate valve 200 is equipped with solenoids 202 that open the gate 201 against return springs 203 when an electrical current is applied.

The battery or batteries located in the battery box 225 can be standard 12 volt storage batteries. While these are preferred, any other types of batteries are within the scope of the present invention. The battery box 225 typically also contains a timer 251 that times when to dispense feed and how long. This timer 251 can control the spin cast 220 and the solenoids 202. Typically, the timer 251 causes the gate 201 to open while the spin cast member 220 is rotating.

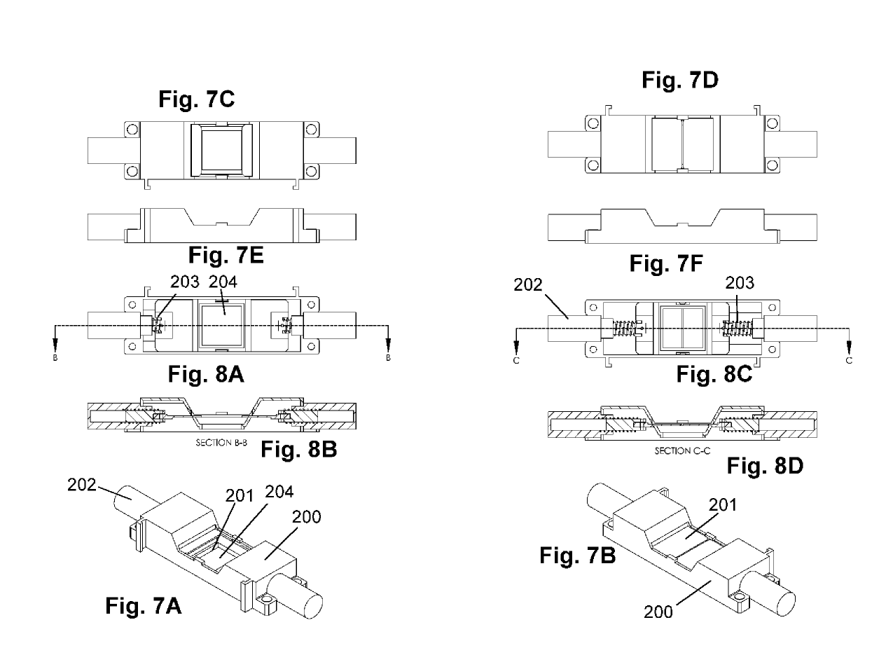

Turning to FIGS. 7A-7F, details of the sliding gate valve 200 can be seen. FIG. 7A shows an embodiment of the gate valve 200 in the open configuration where feed can be dispensed. Solenoids 202 at each end of the device can linearly pull a pair of sliding gates 201 apart to open the portal 204 such that feed can exit. FIG. 7B shows the gate valve 200 in a closed configuration. The closed gate 201 can be seen. The sliding gates and/or baffle plate are preferably made of metal; however, they can also be made of plastic or other rigid material. If made from metal, aluminum is preferred to avoid corrosion.

FIGS. 7C and 7D show a top view of the open and closed configurations respectively, while FIGS. 7E and 7F show side views.

FIG. 8A shows a top-down view of the gate valve 200 in the open configuration. Covers have been removed showing the return springs 203 in a compressed state (pushing against the solenoid 202). FIG. 8B is a section of FIG. 8A along the section line shown in FIG. 8A. The relationship between the solenoids, return springs and sliding gates can be seen.

FIG. 8C shows the same gate valve 200 as FIG. 8A however, in the closed configuration. Here the return springs 203 can be seen in a relaxed state. FIG. 8D is a section of FIG. 8C taken along the section line shown in FIG. 8C. Again, the relationship between the solenoids, return springs and sliding gates can be seen.

While any type of electrically controlled gate is within the scope of the present invention, a double linear actuator as shown in FIGS. 7-8 is preferred. Also, it is preferred to mount the gate valve internally in the feeder. This prevents wasted feed due to movements of tailgate type feeders or due to wind or brushing by animals. Also, an internal gate valve is not exposed to the elements. Even though it is preferred to mount the gate valve internally, it is within the scope of the present invention to mount it anywhere.

Several descriptions and illustrations have been provided to aid in understanding the present invention. One with skill in the art will realize that numerous changes and variations are possible without departing from the spirit of the invention. Each of these changes and variations are within the scope of the present invention.

We claim:

1. A gate valve attachment that can be added to an animal feeder of a type having a spin cast mechanism comprising:
a pair of flat sliding members moving in opposition to one-another that form a gate that prevents or allows distribution of feed from the feeder onto said spin cast mechanism;
said sliding members each being attached to a solenoid and each acting in cooperation with a return spring, the return spring being configured so that force from the solenoid, when activated by an electrical current, acts against a return force supplied by said return spring;
wherein said solenoids cause said gates to open when an electric current is applied to said solenoids allowing said feeder to dispense feed onto said spin cast mechanism, and said return springs cause said gates to close when said electric current is removed preventing said feeder dispensing feed onto said spin cast mechanism.

2. The gate valve attachment of claim 1 further comprising a baffle plate mounted horizontally above said sliding members.

3. The gate valve attachment of claim 2 wherein said baffle plate is held above said sliding members by a plurality of legs.

4. The gate valve attachment of claim 1 wherein said solenoids are electrically connected to and controlled by a timer.

5. The gate valve attachment of claim 1 wherein said sliding members are in a housing.

6. The gate valve attachment of claim 1 wherein said housing is held in place in the feeder by at least one magnet.

7. The gate valve attachment of claim 1 wherein said gate valve attachment is adapted to be actuated remotely via a wireless interface.

8. A gate valve that can be added to an existing animal feeder of the type having a spinning member located below a feed exit portal, the gate valve being mounted internally in the feeder covering the feed exit portal in feed communication with said spinning member, the gate valve including at least one sliding flat gate mechanically attached to at least one solenoid that causes the flat gate to slide linearly opening the feed exit portal when electric current is applied to the solenoid allowing feed to move out of the exit portal onto the spinning member, the flat gate cooperating with at least one return spring that causes the flat gate to close the feed portal when electric current is removed from the solenoid preventing feed from moving out of the exit portal.

9. The gate valve of claim 8 that includes two sliding gates, two solenoids and two return springs.

10. The gate valve of claim 8 wherein the solenoid is actuated whenever the spinning member is actuated.

11. The gate valve of claim 10 wherein the solenoid and the spinning member are actuated by a timer.

12. The gate valve of claim 8 wherein said spinning member and said sliding gates are adapted to be actuated remotely by wireless control.

13. An animal feeder control gate comprising, in combination:
a spinable member located below a feed exit portal in an animal feeder;
a removable housing located over said feed exit portal;
said removable housing containing two flat plate, opposing sliding gate members, said sliding gate members being solenoid actuated.

14. The animal feeder control gate of claim 13 further comprising a return spring attached to each of said sliding gate members.

15. The animal feeder control gate of claim 13 wherein said spinable member and said sliding gate members are adapted to be actuated by a timer.

16. The animal feeder control gate of claim 13 wherein said spinable member and said sliding gate members are adapted to be actuated wirelessly from a remote location.

17. The animal feeder control gate of claim 13 wherein said spinable member and said sliding gate members are powered by a rechargeable battery.

18. The animal feeder control gate of claim 17 wherein said rechargeable battery is recharged by a solar panel.
